(19) United States
(12) Patent Application Publication
(10) Pub. No.: US 2010/0198734 A1
(43) Pub. Date: Aug. 5, 2010

(54) Method and System for Integrating an Entertainment-Based Project with a Method and System from the Financial Protocol of a Financial Institution Via a Communications Network

(75) Inventors: Cary Wayne Durkin, Los Angeles, CA (US); Larry C. Anderson, JR., Lake Balboa, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: THE CARLAR GROUP, Los Angeles, CA (US)

(21) Appl. No.: 12/608,987

(22) Filed: Oct. 29, 2009

Related U.S. Application Data
(60) Provisional application No. 61/110,445, filed on Oct. 31, 2008.

(51) Int. Cl. G06Q 10/00; G06Q 50/00; G06F 3/048

(52) U.S. Cl. 705/301; 705/348; 715/772

(57) ABSTRACT

A method and system of integrating an entertainment based project that include entertainment, story premises, characters, character arcs, production specifics, production specifics, data via the Internet and/or software to a financial, distribution, marketing, talent coordinating, and public relations (hereinafter referred to as “institutions”) financial institution's protocol to lessen or increase the financial, distribution, marketing, talent coordinating, and public relations value of the entertainment project in order to finance, distribute, sell, rent, and/or lease the entertainment project is described. A streamlined, “one word/one button/filtered, oriented application of the described method and system can reduce a number of interactions between agencies, managers, studios, individual artists, including manual, personal communications with each entity. Furthermore, the method and system will provide a systematic, detailed, project overview presentation of the entertainment project in which a financial institution is normally accustomed to viewing.

### CROSS-REFERENCE TO RELATED APPLICATION

This application claims the benefit of U.S. Provisional Application No. 61/110,445, filed Oct. 31, 2008.

### BACKGROUND

### Technical Field

The invention relates to computer software and a method of integrating an entertainment based project comprised of entertainment detailed specifics which lessen or increases critical acclaim, audience popularity, primary and secondary target audiences, level of venue size and distribution capabilities, specific genres of audience members, financial value and security to the financing, distribution, sale, lease, security, ranking of commercial viability, and/or or rental of that particular entertainment based project according to financial protocol and specifications by a financial project producing institution.

### BRIEF DESCRIPTION OF THE DRAWINGS

FIG. 1 shows a flow chart outlining operations for generating a project overview.

FIG. 2 shows a system diagram for a project overview system.

FIG. 3 shows a flow chart of actions for directing a client the selection of a genre and certain talent, including a director for a project, in generating a project overview.

FIG. 4 shows a flow chart of actions directing a client through the selection of a director based on a director's price quote.

FIG. 5 shows a flow chart of actions directing a client through the selection of a director based on a director's availability.

FIG. 6 shows an example portion of a project overview which identifies a selected director.

FIG. 7 shows an example portion of a project overview which compares projected box-office earnings throughout the world.

FIG. 8 shows a flow chart of actions directing a client through the planning of a story.

FIG. 9 shows a flow chart of actions directing a client through the planning of a song.

FIG. 10 shows a flow chart of actions directing a client through the selection of a music producer.

FIG. 11 shows a flow chart of actions directing a client through the selection of a musical artist.

FIG. 12 shows a flow chart of actions directing a client through the selection of a session musician.

### DETAILED DESCRIPTION

A method and system of integrating an entertainment based project comprised of entertainment, story premises, characters, character arcs, production specifics, production specifics, data via the Internet and/or software to a financial, distribution, marketing, talent coordinating, and public relations (hereinafter referred to as “institutions”) financial institution's protocol to lessen or increase the financial, distribution, marketing, talent coordinating, and public relations value of the entertainment project in order to finance, distribute, sell, rent, and/or lease the entertainment project is described. A streamlined, “one word/one button/filtered, oriented application of the described method and system can reduce a number of interactions between agencies, managers, studios, individual artists, including manual, personal communications with each entity. Furthermore, the method and system will provide a systematic, detailed, project overview presentation of the entertainment project in which a financial institution is normally accustomed to viewing. For example, the entertainment project will present the premise, characters, character arc, theme, and viability of the project and enter into a compatible, business format that financial institutions recognize. In one embodiment, a server system assigns a unique project identifier to each entertainment data category (client system). The server system also stores specific, entertainment data for each entertainment category and financial institution category for the purchasers of entertainment project. The server system maps each data identifier for the purchaser to enter their specific entertainment data. The server system provides several maps for the specific category of the entertainment data requested by the purchaser. If so mapped, the server system provides the specific background data of each category for the purchaser and their entertainment project. If enabled, the server system sends the requested information to the client (user, for example, a project owner and/or creator) computer system (e.g. via a web page or filtered page) with an indication of the single action to perform to proceed to a next level of the completion of the itemized and systemized function of the server system. When all appropriate actions are performed, the server system generates a completed project overview that a client (user) can present to financial institutions or other individual or entity to fund a project.

In one embodiment, the system and method combines the system commands of the specific software and the data commands of available internet data to complete the client system requirements at the client's machine (e.g., computer, processor). The system and method communicates through the software and the available internet data to provide the client system with a custom, current, streamlined, proprietary version of a project integrating the most current, available, qualified, cast and crew specifications of a project. Representatively, the system and method will merge and integrate the premise, characters, performers, production crew, agents, managers, attorneys, financiers, distributors, promotions, sales, and marketing of an entertainment based project with the business protocol generally required of many financial/manufacturing/distribution entities. The system will then present the integrated information in a final product that is formatted for a particular industry, such as a report format that may be printed that is commonly presented to financial decision-makers.

A system and a method for entering and merging a project by a writer, producer, director, storyteller, artist for a project comprising entertainment values allowing entering an itemized system of business and financial protocols and standards established by the financial and entertainment industries is described.

In general, financial and entertainment decision-makers require a detailed project overview to be submitted for consideration to fund and execute a project. Such project overview includes not only the creative work (e.g., screenplay, play, etc.) but identification of key talent (e.g., cast, production, direction, public relations, etc.) and a budget and time line for completing the project. The necessary data to generate such a project overview may be available either through databases (e.g., IMBD for talent) or through business contact(s) with, for example, studios and financial institutions. Though the information may generally be available, culling through the information and piecing it together to generate a coherent project overview is generally extremely time consuming.

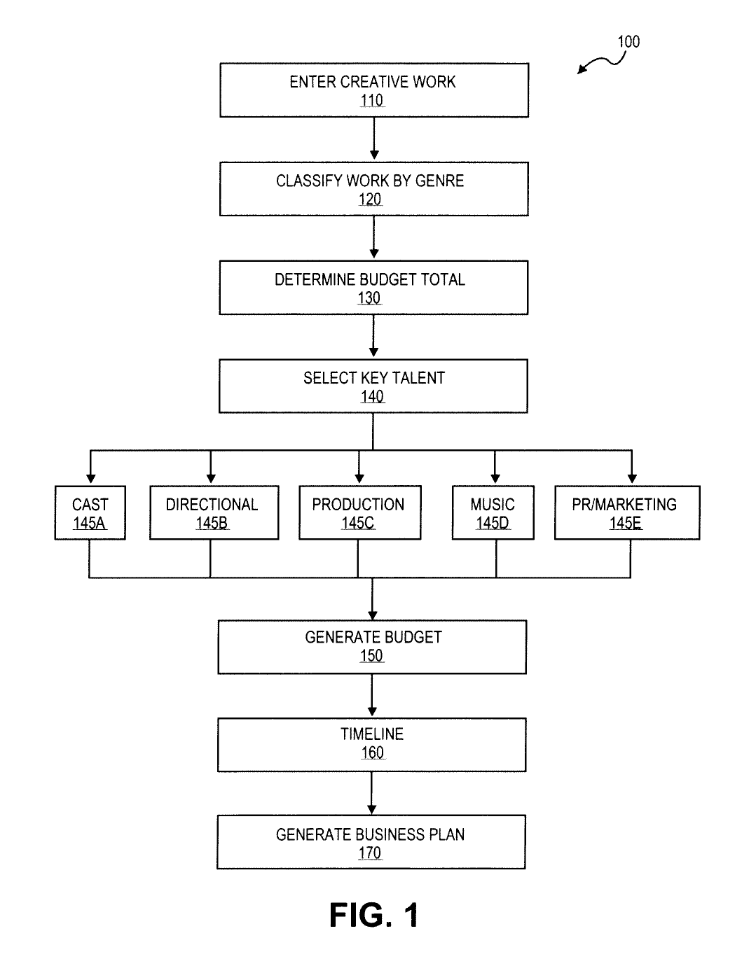

FIG. 1 shows a flow chart of a method to generate a production staff, project overview, executive assistant, and/or a business plan (hereinafter “project overview”) suitable for decision-makers in financial and entertainment industries to review an entertainment project such as a proposed movie project. In one embodiment, the method is embodied in machine-readable software having stored thereon data and instructions, which cause a programmable processor to perform various operations described. Such software may be an internet application that is downloadable or otherwise accessible as a single source or multiple sources by a client. In other embodiments, the operations might be performed by specific hardware components that contain hardwired logic. These operations might alternatively be performed by any combination of program computer components and custom hardware components. An operation of generating a project overview may further involve communication with a printing machine to generate a paper copy or an electronic communication in which the project overview may be electronically mailed or accessed.

Referring to FIG. 1, a method for generating a project overview (method 100) begins by prompting a client (e.g., an individual) to enter a creative work such as a screenplay, story, play, music recording or performance, music compilation (e.g., record, compact disc recording, etc.), internet production, convention, gala, etc. (block 110). The following discussion is directed at a screenplay or film. It is appreciated that the teachings described herein can be applied to other entertainment projects, including but not limited to, television projects, stage performances, music recordings or performances, internet productions and convention performances.

Once the creative work is entered into the system, the system prompts the client to classify the work by genre (block 120). Examples of genre for a screenplay include, but are not limited to, drama, comedy, fiction, horror, etc. The system also prompts the client to determine a budget total that may be used to select key talent (block 130). In another embodiment, a budget total is not predetermined but might be determined based on a selection of desired key talent and/or other information as described below.

Continuing with method 100 of FIG. 1, a system will prompt a client to select key talent (block 140). Key talent for a motion picture may include key members of cast (block 145A), director (block 145B), producer (block 145C), distributor music (block 145D) and public relations and marketing (block 145E). In one embodiment, a computer system may store the necessary data identifying possible key talent in a database. In another embodiment, the system links to databases storing information regarding key talent. Examples of databases storing information regarding key talent include www.imdb.com, www.imdbpro.com, www.studioreferralservices.com, www.boxofficemojo.com, www.boxofficeguru.com, and www.lascasting.com. In one embodiment, the system links to a database and allows the client to enter the linked database and select key talent. The selection of key talent might be driven by the requested price of a cast member or director or other talent for a project, the availability of the individual for time period in which the project will take place, the ability of the individual to work with other desired key talent, etc.

Once the key talent is selected, the system generates a budget for the project (block 150). The budget may be determined by the selected individuals/organizations making up the key talent as well as other considerations (e.g., location, props, etc.). The system also prompts the user to enter a timeline for the project (block 160). For example, where the project is a movie, the timeline might include a time for the actual production (e.g., shooting a movie) as well as post-production (e.g., cutting, re-shooting, music laying, etc.). In one embodiment, the selection of key talent is determined in part by the availability of various individuals or organizations selected as key talent. The system and method will coordinate the availability of the talent during the time period selected in making a timeline. For example, if a desired director is committed to directing a picture in the third quarter of the year, the director would not be available to the client at that time. Where a conflict arises between talent and the timeline, the system will prompt the client of the conflict and allow the client to select alternate talent or to adjust the timeline or budget. Once all conflicts are resolved, data is stored (e.g., in a memory of the client's computer system) to generate a project overview including the data with, for example, additional data as described below (block 170).

Through a system of prompts and selections guided by the system and method, the client system can collect such information as characters, character breakdown, age range premise, theme, setting of the story, character arc, audience attraction of the premise, and merge with the business of entertainment containing of contemporary artists to portray the characters, a producer to put the team together, a director to oversee that the portrayals of the characters are in synchronicity and that it stays close to the story the entertainment is based on, a musical team to provide stimulating audio, a public relations team to market the story, to locate a group that will finance the project, to locate a synergistic entity to distribute the entertainment, and to justify to the financial entity that the entertainment is worth financing. The collected information is stored to be used to generate a coherent project overview that decision-makers may use to review the project.

In one embodiment, the system and method also provide a forecast of the projected revenue of the project. If the project is, for example, a film, the system and method can forecast what the film will gross (gross revenue) by comparing the project film to past similar films of, for example, a similar genre and/or budget. For example, the entertainment industry generally tracks the gross revenues received by a film at the box office, both in the United States and foreign countries. This data is collected and stored at multiple databases (e.g., www.boxofficemojo.com, boxofficeguru.com). In this embodiment, to generate a financial forecast for a film, the system is directed to search for such data whether it might be available in a single location or multiple locations. For example, if the project film is estimated to cost $50 million to make and distribute, in one embodiment, the system and method will query known databases or search engines for similarly budgeted past films of the same genre (e.g., drama, comedy, etc.) and/or budget (e.g., with a search criteria of plus or minus $10 million, plus or minus $20 million, etc.). The list of possible past films and their respective gross revenue can vary by adding, for example, a date restriction (e.g., not to exceed the past five years). Further, the system and method can also add a country restriction for past films or sort project revenues on a country by country basis or a worldwide basis. This data may be added to the project overview generated by the system and method. The past films are then presented in terms of their genre and/or budget and their gross revenues, optionally, by country.

By implementing a forecast of the projected revenue of the project, the system and method described herein merges information about the commercial feasibility of starting and completing a project with financial information that may give some indication of whether the project will be successful. Since decisions about financing a project may involve both the creative judgment and financial wisdom of decision-makers, the data the decision-makers need to finance a project may be displayed in a single project overview. Thus, the system and method described herein provide decision-makers with realistic information about the project, the team involved, and the relevant financial data in a single report generated by linking to available databases, identifying relevant data and presenting the relevant data in a form that decision-makers can understand.

It is appreciated that many projects are time dependent and coordinating talent, facilities and equipment are often determinative of the success of a project. In another embodiment, the system and method provides calendaring and tracking information to the client. The system and method in one embodiment may take calendaring information provided by a user and generate a trackable calendar that the user may use to track a project possibly using calendaring software available to a client through another application.

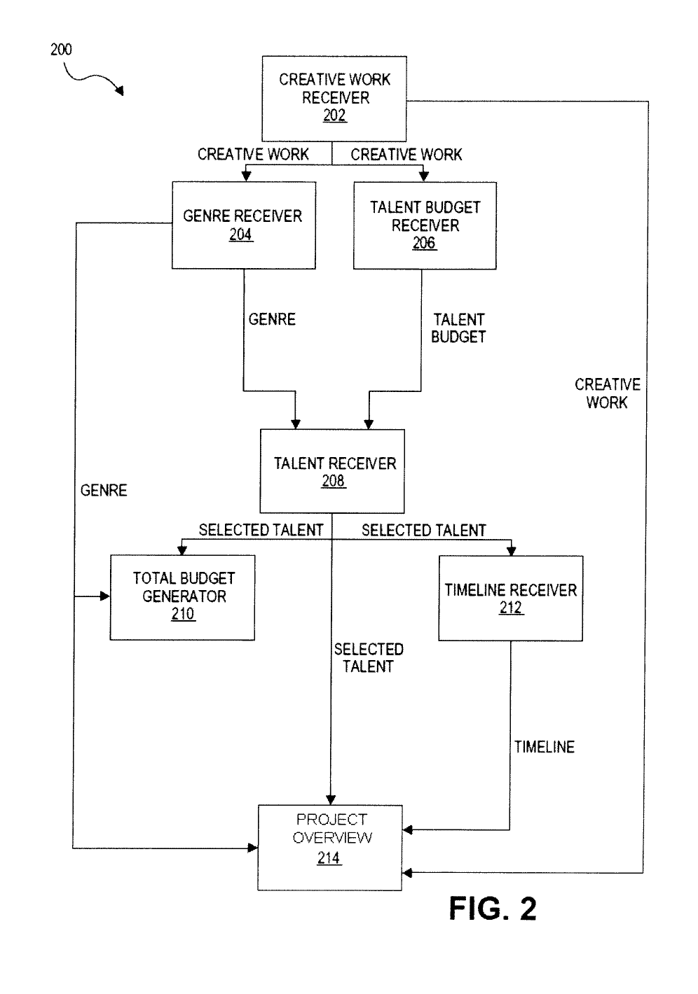

FIG. 2 shows project overview system 200 that generates a project overview suitable for decision-makers in financial and entertainment industries to review an entertainment project such as a proposed movie project. The components of project overview system 200 may be specially programmed processors located on a single computer system or located across several computer systems. In one embodiment, some or all of the operations of method 100 may be performed by the components of project overview system 200 as described below.

Project overview system 200 commences operation by prompting a client (e.g., an individual) to enter a creative work such as a screenplay, story, play, music recording or performance, music compilation (e.g., record, compact disc recording, etc.), internet production, convention, gala, etc. using creative work receiver 202. In one embodiment, block 110 of method 100 may be performed by creative work receiver 202.

Once the creative work is entered into project overview system 200, genre receiver 204 prompts the client to classify the work by genre and talent budget receiver 206 prompts the client to determine a talent budget total that may be used to select key talent. In one embodiment, block 120 of method 100 may be performed by genre receiver 204 and block 130 of method 100 may be performed by talent budget receiver 206.

Following the selection of a genre and a budget for the creative work by the client, talent receiver 208 prompts a client to select key talent for the creative work. Key talent for a motion picture may include key members of cast, director, producer, music distributor, public relations and marketing personnel. In one embodiment, block 140 of method 100 may be performed by talent receiver 208.

Once the key talent is selected, total budget generator 210 of project overview system 200 generates a total budget for the project. The total budget may be determined by the selected individuals/organizations making up the key talent as well as other considerations (e.g., location, props, etc.). Project overview system 200 also prompts the user to enter a timeline for the project using timeline receiver 212. For example, where the project is a movie, the timeline might include a time for the actual production (e.g., shooting a movie) as well as post-production (e.g., cutting, re-shooting, music laying, etc.). In one embodiment, block 150 of method 100 may be performed by total budget generator 210 and block 160 of method 100 may be performed by timeline receiver 212.

Upon the collection of all information for the project, project overview system 200 stores the information in a memory module of the client's computer system. Thereafter, plan generator 214 may generate project overview which incorporates these pieces of information into a report.

Below are a set of examples which demonstrate the functionality of method 100 and project overview system 200. These examples are not intended to limit the scope of the application and are merely illustrative of particular embodiments.

### Example 1

### Selection of Director

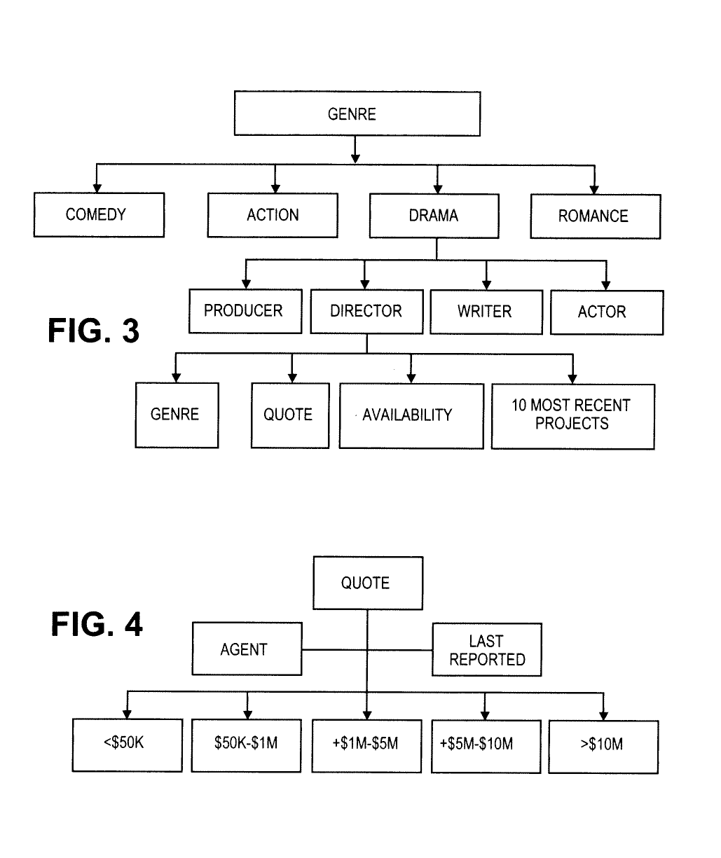

A system of creating a project overview is presented to a client through the client's computer either as software downloaded or an internet web page. FIGS. 3-5 illustrate block diagrams that describe a portion of that process. The client enters his/her screenplay for a film. The project is a film that has a dramatic story line. The client is prompted to associate the project with a specific genre. As shown in FIG. 3, in one embodiment, the client may be provided with a choice of genres, such as comedy, action, drama, and romance, and asked to select from the available choices.

The film needs a specific director. In this example, the client is prompted to select key talent by genre. Referring to FIG. 3, by selecting the genre “Drama,” a talent list appears for the project, in this case showing producer, director, writer, and actor. In FIG. 3, in response to a prompt, the client selects Director.

The software, through data warehousing, now integrates with www.imdbpro.com to provide a list of ten potential directors in that genre, along with the director's price quote, the director's availability and his/her 10 most recent projects.

The client is prompted to select, for example, a button showing the director's 10 most recent projects.

The software, through data warehousing, integrates with www.imdbpro.com to provide a list of the ten most recent films associated with a selected director. The software lists the films in chronological order in the client's project overview.

After reviewing 10 most recent films of various directors, the client can get information about a price quote for a director. For example, in one embodiment, the client may refresh the client's screen (e.g., go back) to the director information provided in FIG. 3. Referring to FIG. 4, the client may then be prompted to select “Quote,” and then prompted to make another selection, a price range from less than 50K, 50K-1M, 1M-5M, 5M-10M, and greater than 10M up, and then accesses a database via www.imdbpro.com of director's available for that price range. A list of director's quoting a price within the selected price range is then displayed.

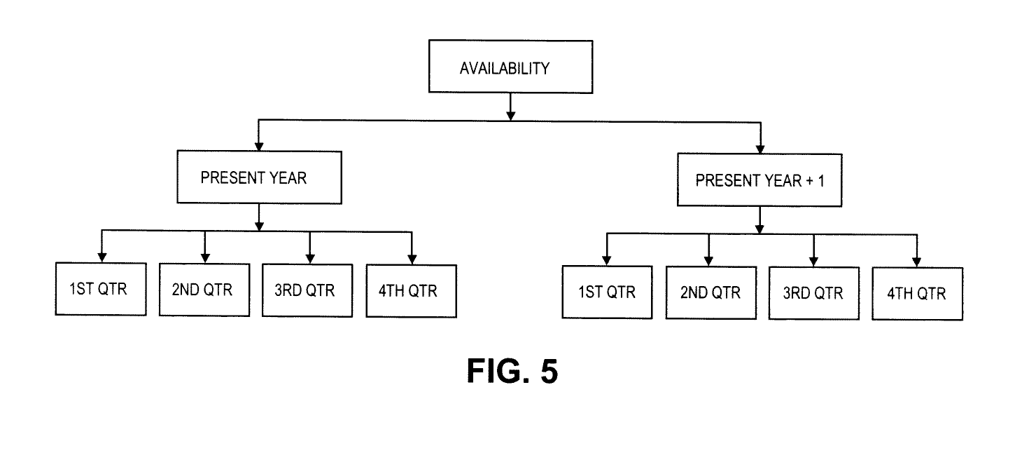

After reviewing price quotes of various directors, the client can get information about the availability of possible directors for the client's project. For example, a desired director may be working on another project and may not be available for a year or more. In one embodiment, the client may refresh the client's screen to the director information provided and be prompted to select “Availability” (see FIG. 3). Referring to FIG. 5, prompts for time frames are then displayed to the client. The client selects a desired time frame and a list of directors available during that time is displayed. For example, the client selects “Present Year,” then selects another “3^{rd} Quarter” which integrates to, for example, the internet database, www.imdbpro.com to provide a list of directors available during the third quarter of the present year.

Through the system of prompts and displayed information, a client may choose a director based on the director's 10 most recent films, a price quote and availability. In another embodiment, the system may select the director based on saved input from the client regarding price quote and availability data supplied by the client by selecting particular fields as described above. In another embodiment, a client may be presented with two or more directors based on price quote and availability by the system. The client may then select a particular director by reviewing each of the presented director's 10 most recent projects. The system provided integrates the noted categories and/or others to provide a reliable and judicious selection of talent. The selected director may then be stored in a client's project overview along with the selected director's information (10 most recent projects, quote, etc.) for incorporation in a final project overview.

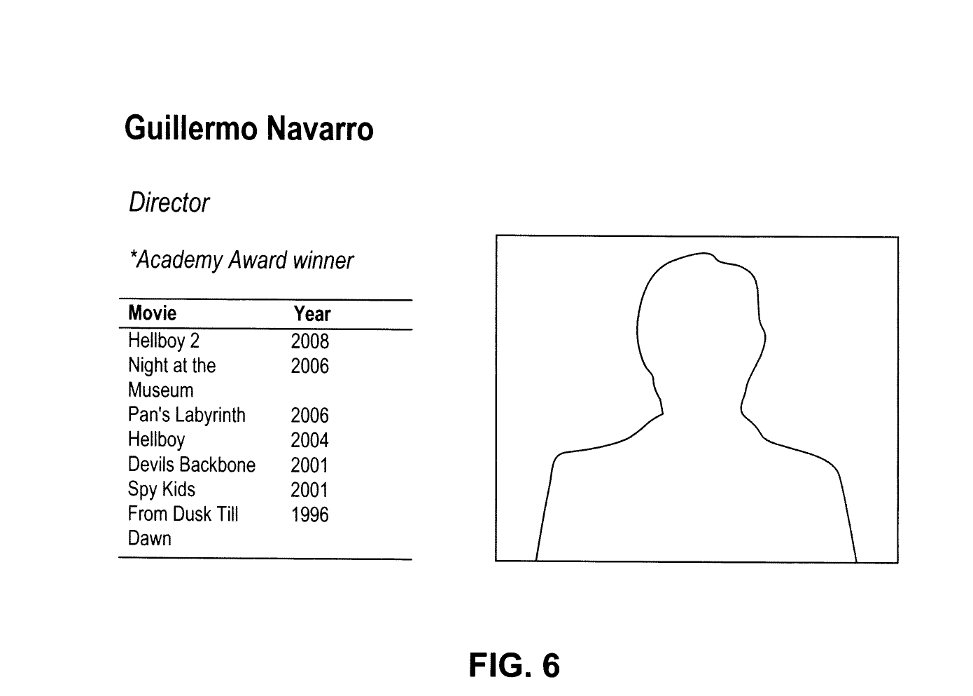

FIG. 6 is an example portion of a project overview which identifies the selected director along with information related to the selected director. Specifically, in this example FIG. 6 identifies the selected director as Guillermo Navarro and lists the most recent films in which the selected director was associated, a notable award the selected director received (e.g. an Academy Award) and a picture of the selected director.

### Example 2

### Production Company and Distribution Strategy

In one embodiment, there may be a number of production companies and distribution companies that may be available to a client to produce and distribute the client's project, a film. Examples of current production companies include: Alameda Films, Alianza Films International, Dark Horse Entertainment, Inca Films, S.A., Univision Productions, USA Films, Venevision Productions, Esperanto Filmoj, Anonymous Content, Lawrence Gordon Productions, Sahara Films, Film Four, Southfork Pictures, and Initial Entertainment Group. Examples of distribution companies include: Univision, Buena Vista Films, Venevision, Focus Features, and 20th Century Fox. While any of these production and distribution companies may be acceptable for a client's project, in one embodiment, a client may wish to select a production company or distribution company based on certain criteria, such as genre of current projects, number of prior projects, budgets of current projects, etc. In one embodiment, the system may gather such criteria as well as contact information from internet wet site sources (e.g., imdbpro.com, google.com) and prompt a user through a selection process similar to that described above in Example 1.

### Example 3

### Financial Forecast

A system of creating a project overview is presented to a client through the client's computer either as software downloaded or an internet web page. The client enters his/her screenplay for a film. The project is a film that has a dramatic story line and the client is prompted to provide the specific genre and other information about the project (e.g., talent, marketing, costs, etc.). The client may be prompted to include a total budget for the project or, based on data provided by the client, a total budget may be calculated by the system.

Once a genre and budget are known, the system prompts the client to generate a financial forecast based on similar past films. The client is queried as to the location for gross revenues of past films (e.g., United States, Europe, Germany, Spain, Japan, etc.) and the client may select a particular country or multiple countries (including worldwide). The client is also queried for a time period (e.g., past two years, past five years, past 10 years, etc.) and a budget range (e.g., plus or minus $10 million). In this example, the client responds to the queries for gross revenues in the United States for the past five years for dramatic films having a budget of $50 million plus or minus $10 million. The system queries entertainment websites (e.g., www.imdbpro.com, www.boxofficemojo.com) and a search engine (e.g., www.google.com) and generates a listing of past films that meet the client's criteria:

| Movie | Release Date | Budget | Gross Revenue (US) |
|---|---|---|---|
| Movie A | December 2007 | $48 million | $274 million |
| Movie B | June 2007 | $60 million | $298 million |
| Movie C | January 2007 | $53 million | $332 million |
| Movie D | January 2006 | $44 million | $247 million |
| Movie E | June 2005 | $51 million | $312 million |

The above report may be added to a project overview (e.g., as a page of a report) in the tabular form shown. In addition, means or averages of the data may also be presented. The average budget of the five films presented above is $51.2 million and the average gross revenue (US) is $293 million. Thus, by one estimation, a projection of a $50 million would yield a gross revenue (US) of $268 million (projected revenue=(projected budget×average revenue)/average budget).

In this above example, genre and budget (and location) were used as the search criteria to generate a financial forecast. In another embodiment, the financial forecast may mine data more specifically by including in its search criteria key talent (e.g., lead actor, director, etc.) or other criteria (e.g., plot, subplot, location, time period, etc.).

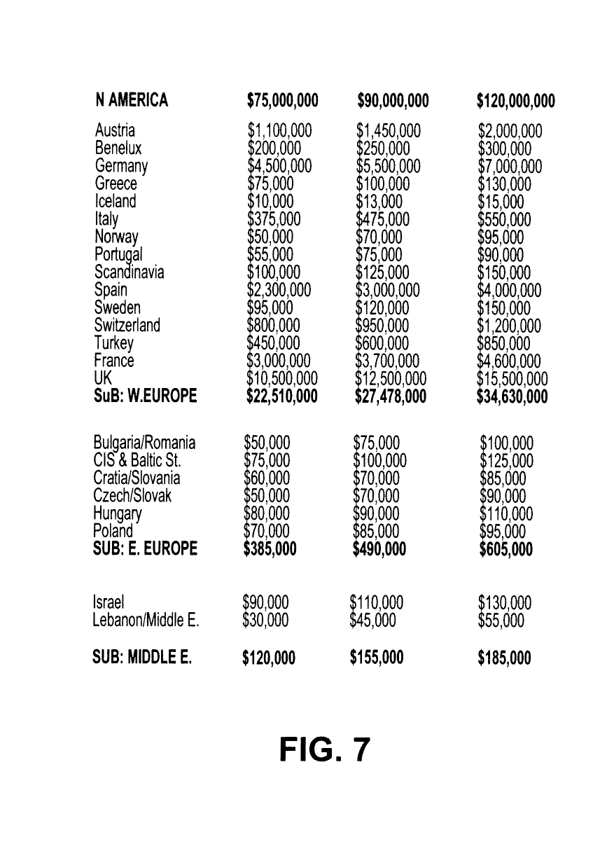

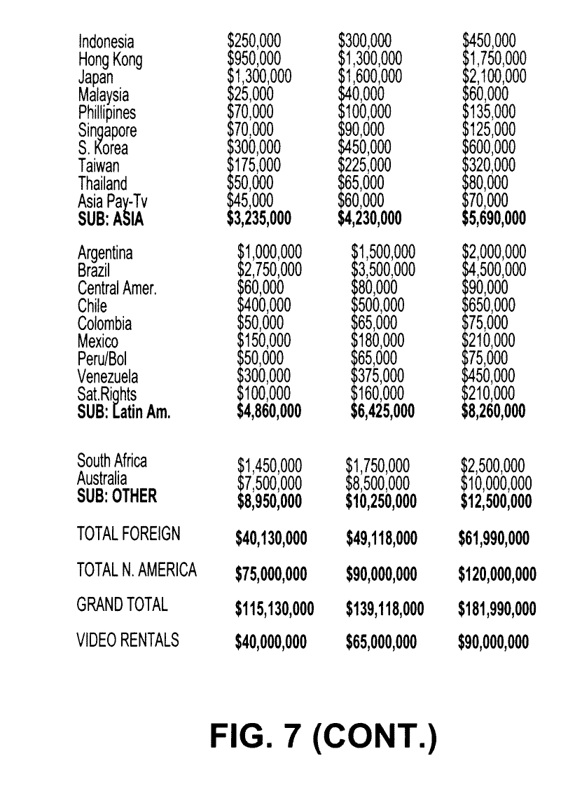

In some embodiments a report may be added to the project overview which shows projected gross revenues for the project based upon region of the world. For example, FIG. 7 shows a report to be included in a project overview in which the projected box-office earnings for several countries and regions of the world are compared against potential box-office gross revenue earned for a project in North America. Specifically, the report shows the projected box-office gross revenues for numerous foreign countries and continents/sub-continents if the project earns $75M, $90M, or $120M in North America through box-office sales. The report also compares projected video rental gross revenue based on projected box-office gross revenue in North America.

The system and method described herein provide the client with an easy to use strategy with a backup strategy for a potential investor, distributor, entertainment executive, and it also assists and services the entertainment community in providing streamline, current data to individuals in the development of their entertainment projects.

In addition to providing viability information about a particular project, the collecting and analysis of financial information also can provide marketing, awareness and/or distribution data that may be analyzed and such analysis added to the report. For example, if a prior project of similar genre and cast grossed significant revenues in Japan and less significant or insignificant revenues in Germany, the report may forecast use of funds available for marketing being spent to a greater degree in Japan relative to Germany. An example might be that the marketing budget in Japan be allocated equal to the percentage of gross revenues that each country generated relative to total gross revenue for a prior project. In another example, the report might propose an opposite marketing budget to try to increase revenues in Germany. Rather than looking at single prior projects, data from multiple projects may be used to generate a marketing budget (e.g., marketing budget based on percentage of average gross revenues for individual countries for multiple prior projects relative to an average total gross revenue). As described, a detailed marketing plan with a basis in past projects may be included in the report.

In addition to a marketing plan, the collection and presentation of financial data for past projects allows forecasting of success of a project based on the assembled team. For example, financial information of similar past projects employing the same director, actor, marketing team, etc. as proposed for the current project, allows for a prediction of success of the current project due, for example, the popularity or skill of the common entity.

### Example 4

### Story Mapping

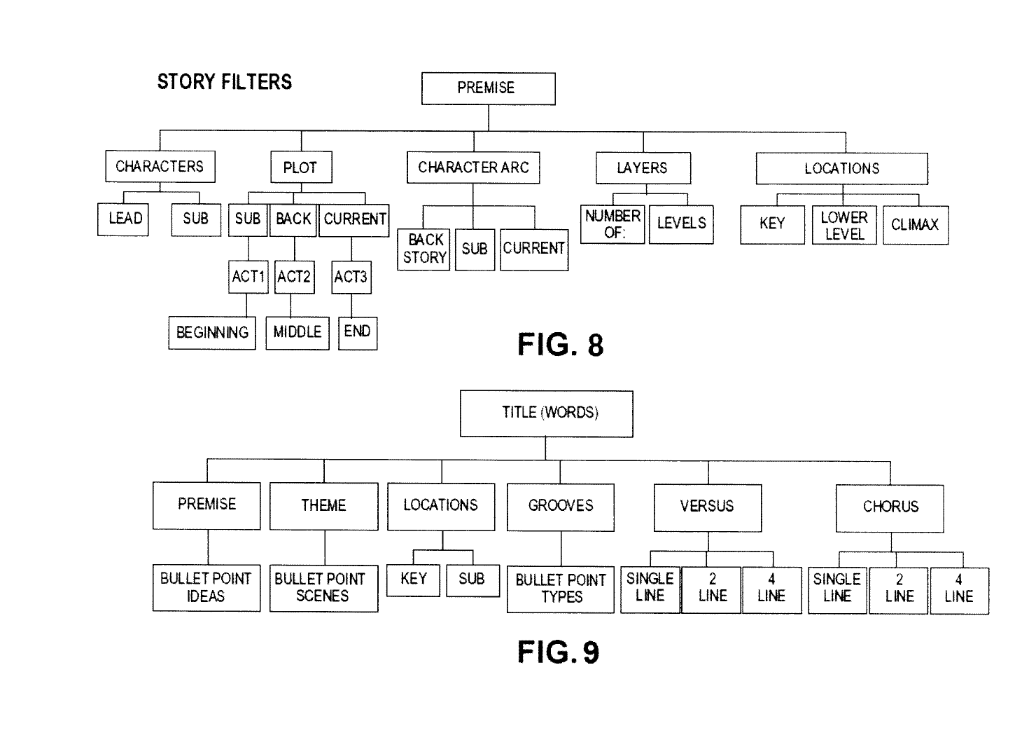

Although the system and method of generating a project overview has been described in relation to a move, in alternate embodiments project overviews may be alternatively generated for other creative works. For example, FIG. 8 shows an example embodiment for mapping a story of a literary work. This embodiment may be incorporated in the process described above to generate a project overview for the literary work.

A user begins by entering a premise for the story. The premise may be associated with a novel, a screenplay, a play, or any other creative literary work. Upon entering the premise for the story, the user is prompted to select a set attributes associated with the story. The attributes may include a set of characters (designated as lead or subordinate characters), a plot, character arcs, layers, and locations related to the story. Each of the attributes is described in greater detail below.

A character may be selected from a local or an external database (e.g. IMDB). Alternatively, a character may be entered manually by the user if the character is not present in a database. Further, each character may be designated as either a lead or subordinate character.

A story may include one or more plots that are designated as either a subordinate plot, a background plot, or a current plot. Further, each plot is associated with a location in the story. For example, a plot may be incorporated in Act 1, Act 2, Act 3, or a combination of acts.

A story may include one or more character arcs corresponding to each selected character. The character arc maps the status of a character as the character transitions through the story. Accordingly, each character arc may include a back story, a subordinate story, and a current story.

A story may include one or more layers. A user may designate the number of layers and the level of each layer in the story.

A story may include one or more locations where the story takes place. The locations may correspond to a key aspect of the story, a lower level aspect of the story, and/or the climax of the story.

Based on selected criteria for the story as described above, method and system of FIG. 8 may produce a segment of a project overview. The segment of the project overview may then be stored and in a memory module of a computer system for incorporation into a full project overview or distribution to a decision maker. Additionally, financial information may be generated in a similar manner as described above in relation to the movie examples (Examples 1-3) and added to the project overview.

### Example 5

### Musical Composition

In some embodiments, the system and method described above may be incorporated to generate a project overview for a musical composition. FIG. 9 shows an example embodiment for constructing a project overview for a musical composition. A user begins by entering a title for the musical composition. Upon entering the premise for the story, the user is prompted to select a premise, themes, locations, grooves, verses, and chorus for the musical composition. Based on the selected criteria, the system and method described above may generate a segment of a project overview. The segment of the project overview may then be stored and in a memory module of a computer system for incorporation into a full project overview or distribution to a decision maker. Additionally, financial information may be generated in a similar manner as described above in relation to the movie examples (Examples 1-3) and added to the project overview.

### Example 6

### Selection of Musical Talent

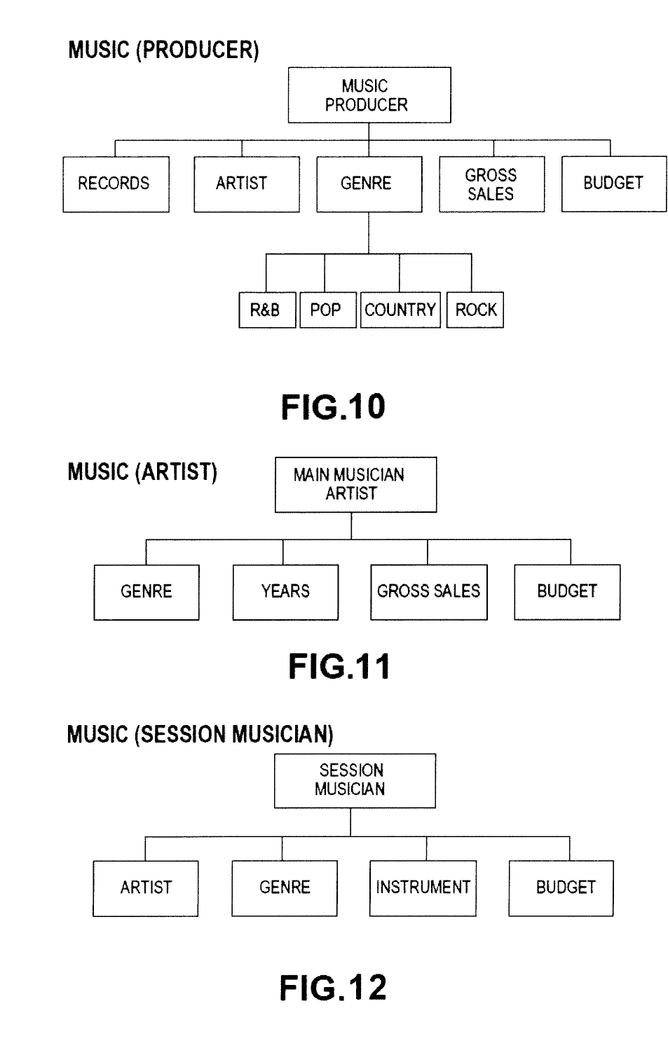

In some embodiments, the system and method described above may be used to select musical talent for a project. FIGS. 10-12 show example embodiments for incorporating a music producer (FIG. 10), a main musician artist (FIG. 11), and a session musician (FIG. 12) into a project overview. In these embodiments, the user may select musical talent based on a set of input criteria. These criteria may include the gross sales of musical talent, the genre of musical talent, gross sales of the musical talent, the budget of the musical talent, the amount of records associated with the musical talent, etc. Subsequently, one or more musical talent is selected for a project and a segment of a project overview is generated. The segment of the project overview may then be stored and in a memory module of a computer system for incorporation into a full project overview or distribution to a decision maker. Additionally, financial information may be generated in a similar manner as described above in relation to the movie examples (Examples 1-3) and added to the project overview.

By utilizing a series of prompts provided by the system and method described above, necessary data to generate such a project overview may be accessed and provided to a client at the client's machine (e.g., computer). The system and method tracks data requested/selected by the client, and presents that data into a report or plan customary to the industry. The presentation format may include, for example, a cover page, table of contents followed by data including a mission statement, executive summary, talent, comparables, financial forecasts, etc. It is appreciated that other formats suitable to the client or acceptable for other industries may be substituted and can be offered by the system for selection by the client.

Unlike other scriptwriting, entertainment, and producing software and websites, user(s) can utilize the system and method for the entire development, pre-production, production, and post production process. The described system and method bridges the gap between concept and creation in a cohesive manner that in one aspect produces a cohesive, organized report in a format acceptable to industry decision-makers.

The system and method described herein will: allow user(s) to start with an entertainment concept; organize their ideas onto a template; attach potential talent to that template from an entertainment database and import pertinent business information to the final product; create a product, which continually updates (due to scheduling conflicts, lack of interest, contract disputes), and is used to generate interest from potential investors, distributors, as well as cast and crew.

Since generally sensitive information (i.e. cast and crew members' salaries, schedules, contact information) is used in creating the project overview, security is of the utmost importance. In addition, creating a user-friendly environment, in which the user has the ability to easily update and change information in the project overview is important.

Overall, the system and method described herein performs numerous operations and tasks, including: expanding and simplifying concepts; establishing a real time and future interchangeable Calendaring System; organize key participants; filter, Track, and research more specific candidates for each project; establishing a main and back up strategy for lead cast and crew; provide Forecast Sales Comparisons in specific genres; Filter, Track, and Research Box Office potential for projects in similar genres; taking a single word premise or concept to a completed project; One button Applications and filters.

What is claimed is:

1. A method for constructing a project overview for a project comprising:
prompting a user to input a creative work into a client computer, wherein the project is associated with the creative work;
prompting the user to classify the creative work by genre;
prompting the user to select personnel for the project; and
generating the project overview for the project based in part on the genre of the creative work and the selected personnel for the project.

2. The method of claim 1, further comprising:
generating a total budget for the project based in part on the selected personnel for the project, wherein the generating the project overview takes into account the total budget.

3. The method of claim 1, further comprising:
selecting a timeline for the project based in part on schedules of the selected personnel, wherein the generating the project overview takes into account the timeline.

4. The method of claim 3, wherein the timeline includes a production time and a post production time.

5. The method of claim 3, wherein the selection of personnel is determined in part based on the timeline.

6. The method of claim 1, wherein the project overview comprises:
a summary of the creative work;
a listing and description of the selected personnel;
a projected gross revenue for the project based in part on statistical information associated with a similar project.

7. An article of manufacture comprising a machine readable medium having stored instructions that, when executed by a computer system:
prompt a user to input a creative work into a client computer, wherein the project is associated with the creative work;
prompt the user to classify the creative work by genre;
prompt the user to select personnel for the project; and
generate the project overview for the project based in part on the genre of the creative work and the selected personnel for the project.

8. The article of manufacture of claim 7, wherein the machine readable medium has instructions that causes the computer system to:
generate a total budget for the project based in part on the selected personnel for the project, wherein the generate the project overview takes into account the total budget.

9. The article of manufacture of claim 7, wherein the machine readable medium has instructions that causes the computer system to:
select a timeline for the project, wherein the generating the project overview takes into account the timeline

10. The article of manufacture of claim 9, wherein the timeline includes a production time and a post production time.

11. The article of manufacture of claim 9, wherein the selection of personnel is determined in part based on the timeline.

12. The article of manufacture of claim 7, wherein the project overview comprises:
a summary of the creative work;
a listing of the selected personnel;
a projected gross revenue for the project based in part on statistical information associated with a similar project.

13. A system for constructing a project overview for a project comprising:
a creative work receiver for prompting a user to input a creative work, wherein the project is associated with the creative work;
a genre receiver for prompting the user to classify the creative work by genre;
a talent receiver for prompting the user to select personnel for the project; and
a plan generator for generating the project overview for the project based in part on the genre of the creative work and the selected personnel for the project.

14. The system of claim 13, further comprising:
a total budget generator for generating a total budget for the project based in part on the selected personnel for the project, wherein the plan generator generates the project overview taking into account the total budget.

15. The system of claim 13, further comprising:
a timeline generator for selecting a timeline for the project based in part on schedules of the selected personnel, wherein the plan generator generates the project overview taking into account the timeline.

16. The system of claim 15, wherein the timeline includes a production time and a post production time.

17. The system of claim 15, wherein the selection of personnel is determined in part based on the timeline.

18. The system of claim 13, wherein the project overview comprises:
a summary of the creative work;
a listing and description of the selected personnel;
a projected gross revenue for the project based in part on statistical information associated with a similar project.
